(19) United States
(12) Patent Application Publication
(10) Pub. No.: US 2023/0039011 A1
(43) Pub. Date: Feb. 9, 2023

(54) DEVICE AND METHOD FOR HANGING HEAVY OBJECTS

(71) Applicant: Ali Hussein Amhaz, North Las Vegas, NV (US)

(72) Inventor: Ali Hussein Amhaz, North Las Vegas, NV (US)

(21) Appl. No.: 17/805,506

(22) Filed: Jun. 6, 2022

Related U.S. Application Data
(60) Provisional application No. 63/260,079, filed on Aug. 9, 2021.

(51) Int. Cl. A47G 1/16; A47G 1/20

(52) U.S. Cl. CPC A47G 1/1613; A47G 1/202; G01C 9/34

(57) ABSTRACT

A device and method for hanging objects on a wall is disclosed. The device may be a hanging tool that includes a tubular main body that is elongated, has a rectangular cross-sectional profile, and defines a plurality of evenly spaced fastener openings. In use, this hanging tool is positioned on the wall and mounted thereto. Then, a object is placed on an upper surface of the hanging tool and subsequently hung on the wall.

### CROSS-REFERENCE TO RELATED APPLICATION

This application claims the benefit of priority of U.S. provisional application No. 63/260,079, filed Aug. 9, 2021, the contents of which are herein incorporated by reference.

### BACKGROUND OF THE INVENTION

The present invention relates to the hanging of heavy items and, more particularly, to a reusable single-person mounting assistant, used for hanging and leveling heavy items.

Hanging and leveling heavy items by oneself is difficult. Conventional solutions have many pitfalls. Some solutions have multiple parts and are permanent, while others are less accurate and sturdy. Certain solutions are single-use items, while others require multiple devices to achieve desired results.

As can be seen, there is a need for a reusable single-person mounting assistant device and a novel method of using that mounting device, as detailed herein.

### SUMMARY OF THE INVENTION

In one aspect of the present invention, a method for hanging objects on a wall is disclosed, with the method including the steps of: providing a hanging tool including a tubular main body that is elongated, has a rectangular cross-sectional profile, and defines a plurality of evenly spaced fastener openings; positioning the hanging tool on the wall; mounting the hanging tool to the wall; placing an object on an upper surface of the hanging tool; and hanging the object on the wall.

In certain embodiments, the hanging tool includes at least one level.

In certain embodiments, the at least one level is coupled to an outer surface of the hanging tool.

In certain embodiments, the at least one level is a first level and a second level, with the second level being positioned perpendicular to the first level.

In certain embodiments, the positioning step includes using the at least one level to confirm the hanging tool is level.

In certain embodiments, the method further includes, after the providing step, the step of: identifying a location of a plurality of studs within the wall.

In certain embodiments, the mounting step includes fastening the hanging tool to two or more studs of the plurality of studs using two or more of the plurality of evenly spaced fastener openings.

In certain embodiments, the method further includes the step of providing a plurality of fasteners for fastening the hanging tool to the two or more studs.

In certain embodiments, each fastener supports the hanging tool at two locations along a length of the fastener.

In certain embodiments, the method includes, after the hanging step, the step of: removing the hanging tool from the wall.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in use;

FIG. 2 is an exploded view of the embodiment of the present invention;

FIG. 3 is a perspective rear view of the embodiment of the present invention;

FIG. 4 is a detailed front view of the embodiment of the present invention; and

FIG. 5 is a section taken along 5-5 in FIG. 4.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, an embodiment of the present invention provides a tool for hanging heavy or difficult to handle objects (such as large/bulky items). Embodiments of the present invention create a temporary ledge that assists the individual while mounting heavy items to a wall. Advantageously, the hanging tool is a single piece (with the main body and, in certain embodiments, bubble levels forming an integral unit) and reusable tool that is sturdy and accurate. Embodiments of the present invention hold, stabilize, and help to level heavy/difficult-to-handle items (especially when a single person is mounting the item(s)).

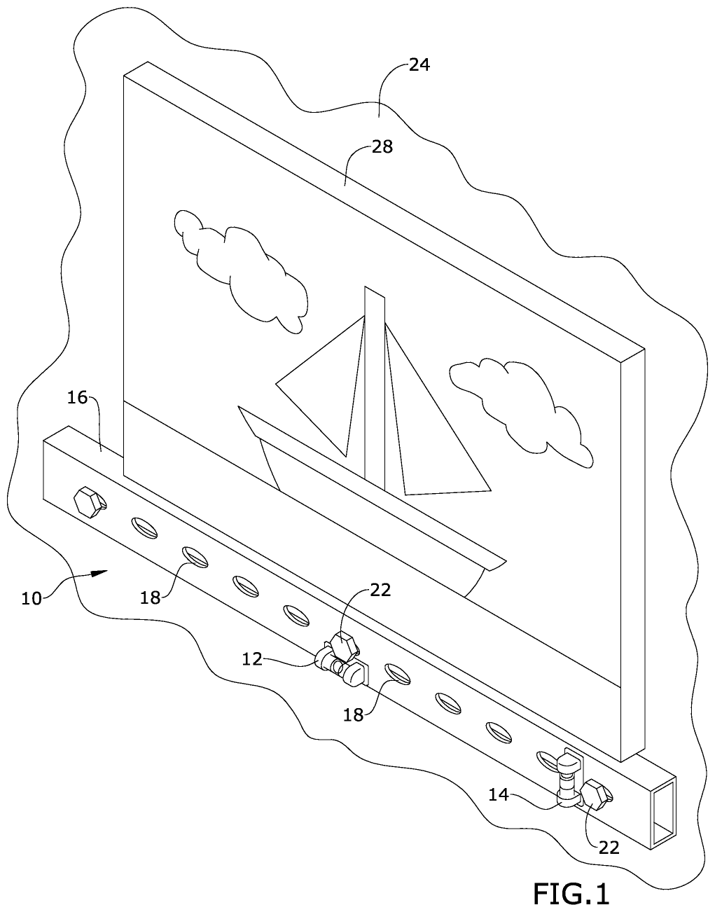

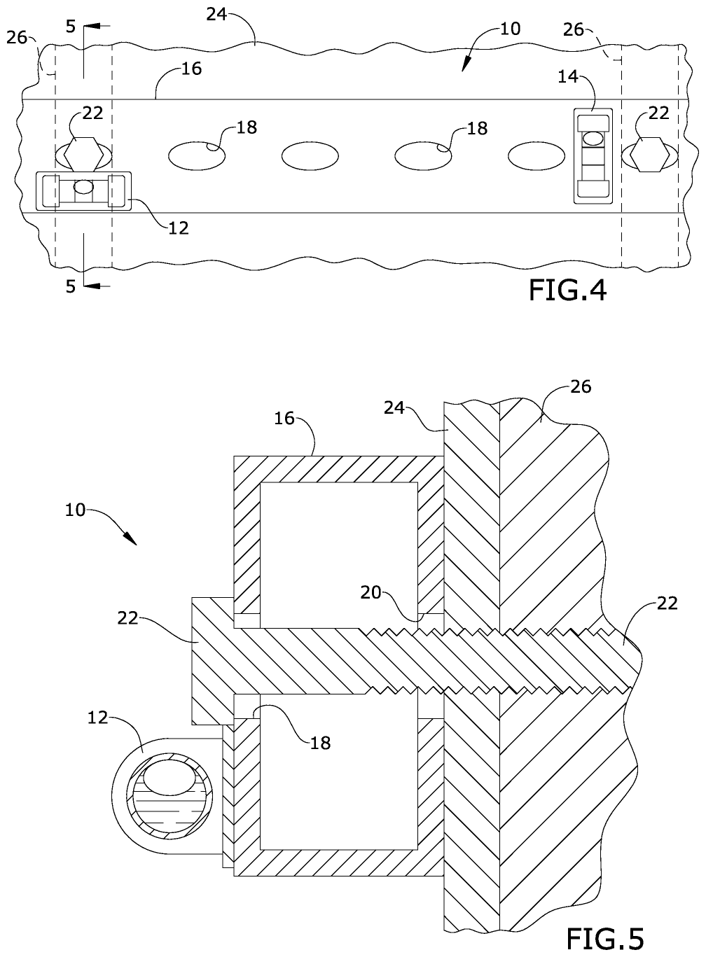

Referring now to FIGS. 1-5, a hanging tool 10 includes an elongated (i.e., its length is greater than its width), rectangular (in cross-section) tube 16 (which forms a main body of the tool 10). In preferred embodiments, the tube 16 is formed from aluminum to be lightweight and easy to use and has a hollow interior. However, other appropriate materials may be used in accordance with the present invention. The tube 16, in use, is used to mount heavy objects 28 on a wall 24 and serves as a ledge or cleat. The hanging tool 10 may also be used as a permanent bracket to secure/support these heavy items, such as shelving.

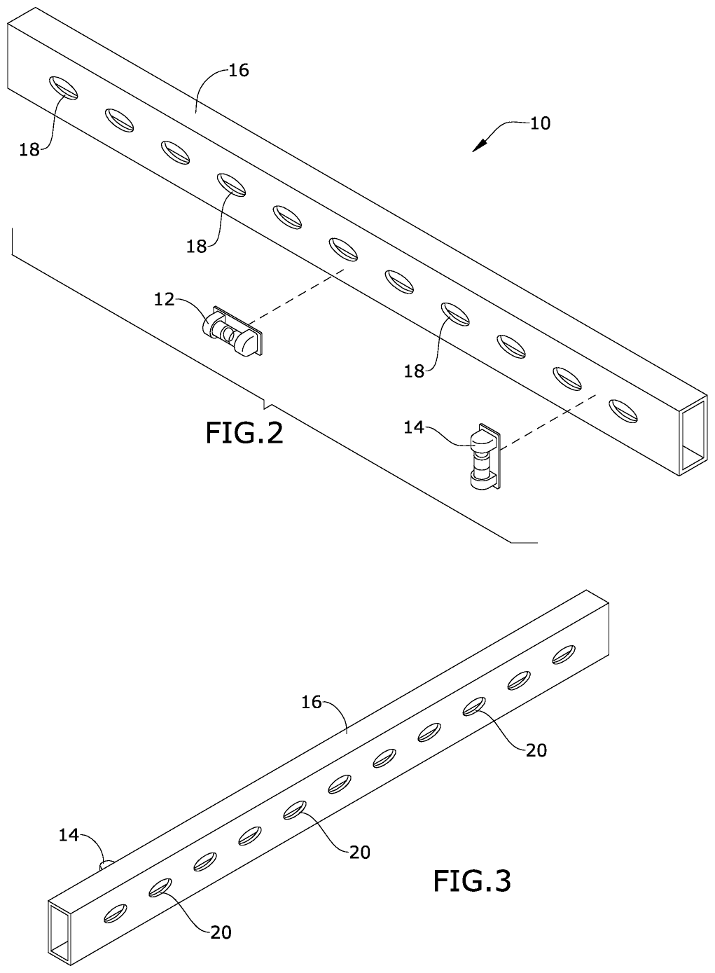

In order to function as a cleat/support ledge, the tube 16 has small fastener holes 18, 20 (which may be, for example, oval in shape) pressed approximately two inches apart from one another. In preferred embodiments, the holes 18, 20 are embodied as slot-shaped (in order to slightly adjust the positioning of fasteners 22 discussed in greater detail below). It will be appreciated by those with skill in the art that other distances may be selected for the spacing of the holes 18, 20. The holes 18, 20 allow for the tool 10 to be attached to wall studs 26 in the wall 24. As shown in FIGS. 2 and 3, each fastener hole 18, 20 is comprised of a through hole 18 on an outer side of the tube 16 and a mounting hole 20 on an inner side of the tube 16.

In use, fasteners 22 connect the hanging tool 10 to two or more of the studs 26. The rectangular/tubular form of the main body 16 provides two points of support to the main body 16 with each fastener 22 used, thus providing superior support thereto. For example, as shown in FIG. 5, because the fastener 22 extends through the through hole 18 and the mounting hole 20, upper edges of each hole 18, 20 can rest on the fastener 22, distributing the load applied to the fastener 22. This shape and interaction with the fastener 22 also reduces the possibility of the main body 16 bending on the outer side when loaded with a very heavy object.

In certain embodiments, further provided is a widthwise oriented bubble level 14 (running vertically in the illustrated embodiment) and a lengthwise oriented bubble level 12 (running horizontally in the illustrated embodiment). Consequently, the levels 12, 14 will be positioned perpendicular to on another, providing more versatility when the hanging tool 10 is being used. However, it will also be appreciated that the levels 12, 14 may be omitted in certain embodiments, or may be placed in different locations than shown (such as within the tube 16 or on a bottom surface thereof).

In an exemplary embodiment, the hanging tool may be used as follows. Step 1: Stud locations are identified within a wall 24. Step 2: The tube 16 is placed on the wall 24 and a user ensures it is level. Step 3: The tube 16 is fastened, using the fasteners 22, to the studs 26 using two or more of the pre-drilled holes 18, 20. Step 4: The object 28 being hung (such as a cabinet or a picture) is placed on top of the tube. Step 5: The object 28 is fastened to the wall studs 26. Step 6: The tube 16 is unfastened from the wall 24 and available for other use.

In an exemplary embodiment, the hanging tool 10 may be made or fabricated as follows. Aluminum/metal tubes 16 (which may be formed or acquired in any appropriate manner) are cut to the desired length, with holes 18, 20 pressed every approximately two inches. One or more bubble levels 12, 14 are optionally attached to the tube 16 using various appropriate means, such as an adhesive.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method for hanging objects on a wall, the method comprising the steps of:
providing a hanging tool comprising a tubular main body that is elongated, has a rectangular cross-sectional profile, and defines a plurality of evenly spaced fastener openings;
positioning the hanging tool on the wall;
mounting the hanging tool to the wall;
placing an object on an upper surface of the hanging tool; and
hanging the object on the wall.

2. The method of claim 1, wherein the hanging tool comprises at least one level.

3. The method of claim 2, wherein the at least one level is coupled to an outer surface of the hanging tool.

4. The method of claim 2, wherein the at least one level is a first level and a second level, with the second level being positioned perpendicular to the first level.

5. The method of claim 2, wherein the positioning step comprises using the at least one level to confirm the hanging tool is level.

6. The method of claim 1, further comprising, after the providing step, the step of:
identifying a location of a plurality of studs within the wall.

7. The method of claim 6, wherein the mounting step comprises fastening the hanging tool to two or more studs of the plurality of studs using two or more of the plurality of evenly spaced fastener openings.

8. The method of claim 7, further comprising the step of: providing a plurality of fasteners for fastening the hanging tool to the two or more studs.

9. The method of claim 8, wherein each fastener supports the hanging tool at two locations along a length of the fastener.

10. The method of claim 1, further comprising, after the hanging step, the step of:
removing the hanging tool from the wall.
